(19) United States
(12) Patent Application Publication
(10) Pub. No.: US 2023/0019989 A1
(43) Pub. Date: Jan. 19, 2023

(54) GOLF BAG TRANSPORT DEVICE

(71) Applicant: Par-Tee Technologies Ltd., Richmond (CA)

(72) Inventors: Xiaoshi Zhang, Coquitlam (CA); Stephen Xue, Richmond (CA)

(21) Appl. No.: 17/305,841

(22) Filed: Jul. 15, 2021

(51) Int. Cl. A63B 55/60; G05D 1/10

(52) U.S. Cl. CPC A63B 55/61; G05D 1/10; A63B 2210/50; G05D 2201/0204

(57) ABSTRACT

A golf bag transport device that is configured to assist in the transportation of a golf bag for a user during a round of play of golf. The present invention includes a base platform wherein the base platform includes drive wheels on opposing sides thereof. The base platform has a vertical golf bag support member extending upward therefrom. The vertical golf bag support member is further constructed to be collapsible. Secured to the vertical golf bag support member are horizontal support members configured to assist in retention of a golf bag. Opposing auxiliary wheels are located proximate the front edge and rear edge of the base platform. The auxiliary wheels are configured to assist in maintenance of the position of the base platform while traversing a sloped surface. Optical sensors are employed to provide collision avoidance and a gyroscopic balancing unit provides self-balancing of the device during use.

### FIELD OF THE INVENTION

The present invention relates generally to golfing equipment, more specifically but not by way of limitation, a golf bag transport device that is operable to transport a golf bag with clubs during a round of play wherein the present invention is easily portable and is designed to automatically follow the golfer using the device of the present invention and further utilize ultra wide band wireless communication protocol.

### BACKGROUND

Millions of people play golf around the world every day. Golf has been played for over a century and is participated in by men and women of all ages. Golf is popular in most developed countries and the world and is played on a golf course. Golf courses can easily extend for many miles and as such there are challenges to transporting a golf bag full of clubs around a golf course. While some golf participants will manually carry their golf bags, this is either undesirable by most or many are physically unable to carry their golf bag and walk the entire course. Additionally, many golf courses do not allow golfers to walk as it typically extends the time of play and as such can make golf course management of players difficult due to a slower pace of play.

One device commonly utilized by golfers is the golf cart. As is known in the art, golf carts are configured to transport not only the golf bags but the players as well. Another device utilized by golfers is known as a push cart. This allows the golfer to enjoy walking the course but allows for a slightly faster pace of play as the golfer utilizes the push cart to transport their golf bag and clubs. While manual push carts do help golfers, they are still undesirable from a user and a course play management perspective.

Current equipment available in the market while foldable is still quite large. The physical size of the existing equipment leaves little to no space available in most trunks and as such is quite inconvenient for most individuals. Additionally, existing equipment is quite heavy and is difficult to lift for many people and can sometimes require an individual to obtain assistance to place the equipment in the trunk of a vehicle.

Accordingly, there is a need for a golf bag transport device that is motorized and facilitates the transport of a golf bag with clubs wherein the user can walk the course during use thereof and wherein the transport device automatically follows the user and provides self-balancing.

### SUMMARY OF THE INVENTION

It is the object of the present invention to provide a golf bag transport device that is configured to receive a golf bag with clubs secured thereto wherein the present invention includes a base platform having two side wheels operably coupled thereto.

Another object of the present invention is to provide a device configured to provide assistance in transportation of a golf bag with clubs during a round of golf wherein the base platform further includes a bag support member extending upward therefrom.

A further object of the present invention is to provide a golf bag transport device that is configured to receive a golf bag with clubs secured thereto wherein the present invention includes an electric motor and power supply configured to drive the two side wheels.

Still another object of the present invention is to provide a device configured to provide assistance in transportation of a golf bag with clubs during a round of golf wherein the base platform has operably coupled thereto auxiliary wheels on the front side and rear side thereof.

An additional object of the present invention is to provide a golf bag transport device that is configured to receive a golf bag with clubs secured thereto wherein the present invention further includes at least one detection sensor wherein the detection sensor is operable to detect objects and provide avoidance thereof.

Yet a further object of the present invention is to provide a device configured to provide assistance in transportation of a golf bag with clubs during a round of golf wherein the bag support member includes a pair of horizontal support members operably secured thereto.

Another object of the present invention is to provide a lightweight, small size and easily portable golf bag transport device that is configured to receive a golf bag with clubs secured thereto wherein the device of the present invention is self-balancing.

An alternate object of the present invention is to provide a device configured to provide assistance in transportation of a golf bag with clubs during a round of golf wherein the auxiliary wheels function to assist the device of the present invention traverse along an uphill or downhill terrain.

Still a further object of the present invention is to provide a lightweight easily portable golf bag transport device that is configured to receive a golf bag with clubs secured thereto wherein the present invention is configured to automatically follow the golfer utilizing the golf bag transport device.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a rear view of an embodiment of the present invention; and

FIG. 2 is a rear perspective view of an embodiment of the present invention; and

FIG. 3 is side view of the present invention.

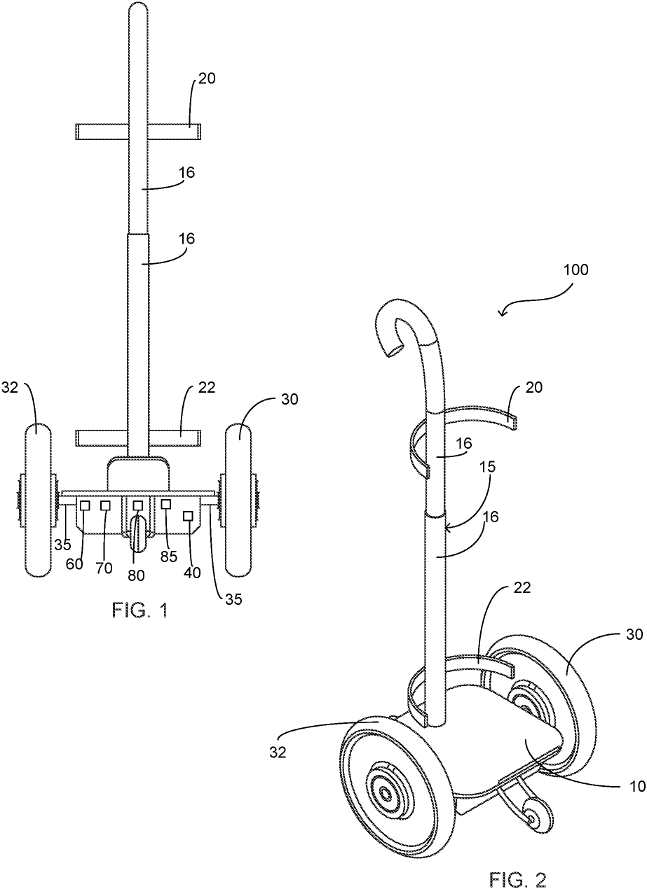

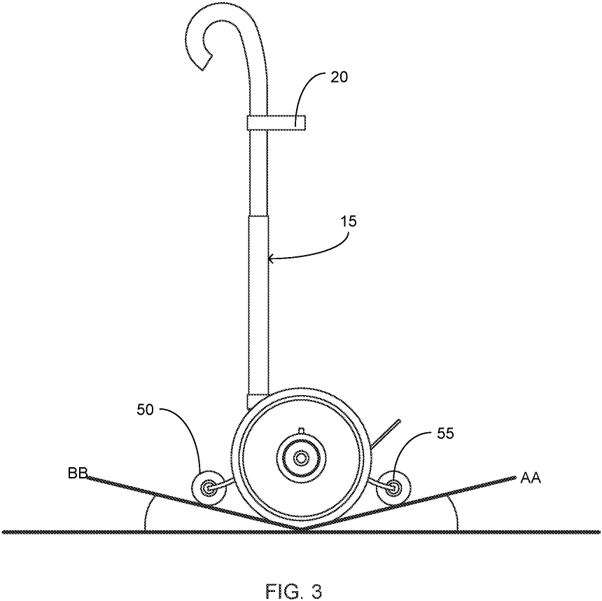

### DETAILED DESCRIPTION

Referring now to the drawings submitted herewith, wherein various elements depicted therein are not necessarily drawn to scale and wherein through the views and figures like elements are referenced with identical reference numerals, there is illustrated a golf bag transport device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular the Figures submitted as a part hereof, the golf bag transport device 100 includes a base platform 10. The base platform 10 is generally square in shape and planar in manner. The base platform 10 is manufactured from a durable lightweight material such as but not limited to aluminum or plastic. The base platform 10 is provided in a size that is suitable to accommodate a golf bag thereon. It should be understood within the scope of the present invention that the base platform 10 could be provided in alternate shapes and sizes. Secured to the base platform 10 and extending upward therefrom is the vertical golf bag support member 15. The vertical golf bag support member 15 is comprised of interconnected telescoping segments 16. It is desired within the scope of the present invention that the golf bag transport device 100 is lightweight and easily transported in a conventional vehicle. As the aforementioned is a desirable objective, the vertical golf bag support member 15 is designed to be collapsible so as to be placed in a trunk of a vehicle but moved to an extended position(illustrated herein) so as to provide the necessary structural support for a golf bag. It should be understood within the scope of the present invention that the vertical golf bag support member 15 could be comprised of alternate quantities of telescoping segments 16.

Secured to the vertical golf bag support member 15 are the upper horizontal support member 20 and lower horizontal support member 22. The upper horizontal support member 20 and lower horizontal support member 22 are u-shaped in a preferred embodiment and are designed to cradle a golf bag for support thereof. While the upper horizontal support member 20 and lower horizontal support member 22 are illustrated having a specific shape herein, it is contemplated within the scope of the present invention that the upper horizontal support member 20 and lower horizontal support member 22 could be provided in alternate shapes and still achieve the desired objective stated herein.

The base platform 10 has drive wheels 30,32 secured to opposing sides thereof. The drive wheels 30,32 are operably coupled to the motor 40 via axle 35 and are operable to provide propulsion of the golf bag transport device 100. The motor 40 is encased in a protective housing and is a conventional electric motor having a power supply operably coupled thereto. It should be understood within the scope of the present invention that the electric motor is a direct current motor having sufficient output to provide a desired speed and wherein the power supply can provide power for at least one full round of golf.

The golf bag transport device 100 further includes a forward auxiliary wheel 50 and a rear auxiliary wheel 55. The forward auxiliary wheel 50 and rear auxiliary wheel 55 function to assist the golf bag transport device 100 traverse a gradient, as represented by line AA and BB. The forward auxiliary wheel 50 is secured to the base platform 10 proximate the front edge thereof and extends outward therefrom. The forward auxiliary wheel 50 is hingedly secured to the base platform 10 so as to accommodate alternate degrees of gradients in either an uphill of downhill direction. Similarly, rear auxiliary wheel 55 is hingedly coupled to the base platform 10 proximate the rear edge thereof. Both the forward auxiliary wheel 50 and rear auxiliary wheel 55 assist in maintaining the proper vertical orientation of the golf bag transport device 100 as the golf bag transport device 100 traverses in either an uphill or downhill direction. The forward auxiliary wheel 50 and a rear auxiliary wheel 55 further provide improved portability and self-balancing of the golf bag transport device 100.

The golf bag transport device 100 further includes an optical sensor 60 mounted underneath the base platform 10. The optical sensor 60 is a conventional optical sensor that is utilized to process object detection so as to inhibit the golf bag transport device 100 from colliding with an object such as but not limited to a rock or golfer. The optical sensor 60 is communicably coupled to a central processing unit 85 wherein upon detection of an obstacle or object with which the golf bag transport device 100 might collide a signal is transmitted to the central processing unit 85 to redirect the golf bag transport device 100. It should be understood within the scope of the present invention that the central processing unit 85 includes the necessary electronics to store, receive, transmit and manipulate data. It should be understood that the optical sensor 60 is illustrated diagrammatically herein and that the golf bag transport device 100 could include a plurality of optical sensors located around the perimeter of the base platform 10.

A transceiver 70 is present on the golf bag transport device 100 and is configured to receive and transmit signals in order to provide automated following of a user of the golf bag transport device 100. The transceiver 70 is communicably coupled to the central processing unit 85 and is further communicably coupled to a second transceiver(not illustrated herein) wherein the second transceiver is secured to the user of the golf bag transport device 100. The transceiver 70 utilizes an ultra wide band frequency or similar wireless communication to operably communicate with the second receiver worn by the user. As the user traverses along the golf course, the transceiver 70 is in constant communication with the second transceiver and is operable to provide direction in which the golf bag transport device 100 will traverse. It is desired within the scope of the present invention that the transceiver utilize a narrow band of wireless communication so as to inhibit interference from alternate wireless devices. It should further be understood within the scope of the present invention that the second transceiver could be a smart phone or similar device such as but not limited to a smart watch enabled by a software application.

Centrally disposed underneath the base platform 10 is the gyroscopic balancing unit 80. The gyroscopic balancing unit 80 is configured to provide self-balancing of the golf bag transport device 100 during use thereof. The gyroscopic balancing unit 80 is a conventional gyroscope balancer that includes a spinning mass and gimbal mount that is configured to provide a generally upright orientation of the golf bag transport device 100 when in use. It should be understood within the scope of the present invention that the golf bag transport device 100 could be provided with or without the gyroscopic balancing unit 80.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A golf bag transport device that is operable to provide transport of a golf bag for a user during a round of play of golf wherein the golf bag transport device comprises:
a base platform, said base platform being planar in manner, said base platform having a front edge and a rear edge, said base platform having a left side and a rear side, said base platform having an upper surface and a lower surface, said base platform having a housing secured to said lower surface thereof;
a vertical golf bag support member, said vertical golf bag support member being operably coupled to said upper surface of said base platform, said vertical golf bag support member having a top end and a lower end, said vertical golf bag support member configured to be collapsible between a first position and a second position, wherein said vertical golf bag support member extends upward from said base platform in said second position;
a pair of drive wheels, said pair of drive wheels being located on opposing sides of said base platform, said pair of drive wheel being operably coupled to a motor to provide rotation thereof; and
a front auxiliary wheel, said front auxiliary wheel being hingedly secured to said base platform proximate said front edge thereof, said front auxiliary wheel extending outward from said base platform.

2. The golf bag transport device operable to provide transport of a golf bag for a user during a round of play of golf as recited in claim 1, and further including a rear auxiliary wheel, said rear auxiliary wheel being hingedly secured to said base platform proximate said rear edge thereof.

3. The golf bag transport device operable to provide transport of a golf bag for a user during a round of play of golf as recited in claim 2, and further including an upper horizontal support member, said upper horizontal support member being secured to said vertical golf bag support member proximate said top end thereof.

4. The golf bag transport device operable to provide transport of a golf bag for a user during a round of play of golf as recited in claim 3, and further including a first transceiver and a second transceiver, said first transceiver mounted to the golf bag transport device, said second transceiver being disposed on the user of the golf bag transport device, said first transceiver and said second transceiver communicably coupled so as to facilitate propulsion of the golf bag transport device in a direction towards the user.

5. The golf bag transport device operable to provide transport of a golf bag for a user during a round of play of golf as recited in claim 4, and further including a lower horizontal support member, said lower horizontal support member being secured to said vertical golf bag support member proximate said lower end thereof.

6. The golf bag transport device operable to provide transport of a golf bag for a user during a round of play of golf as recited in claim 5, and further including a gyroscopic balancing unit, said gyroscopic balancing unit configured to maintain the golf bag transport device in an upright position.

7. The golf bag transport device operable to provide transport of a golf bag for a user during a round of play of golf as recited in claim 6, wherein said upper horizontal support member and said lower horizontal support member are u-shaped.

8. The golf bag transport device operable to provide transport of a golf bag for a user during a round of play of golf as recited in claim 7, wherein said front auxiliary wheel and said rear auxiliary wheel are configured to assist in maintaining the golf bag transport device in the upright position while traversing an inclined surface.

9. A golf bag transport device that is configured to carry a golf bag with clubs for a user during a round of play of golf and further provide automatic following of the user wherein the golf bag transport device comprises:
a base platform, said base platform being planar in manner, said base platform being square in shape, said base platform having a front edge and a rear edge, said base platform having a left side and a rear side, said base platform having an upper surface and a lower surface, said base platform having a housing secured to said lower surface thereof;
a central processing unit, said central processing unit being disposed in said housing, said central processing unit having electronics to receive, store, transmit and manipulate data;
a vertical golf bag support member, said vertical golf bag support member being operably coupled to said upper surface of said base platform, said vertical golf bag support member having a top end and a bottom end, said bottom end being proximate said upper surface of said base platform, said vertical golf bag support member having a plurality of telescoping segments being configured to collapse said vertical golf bag support member between a first position and a second position, wherein said vertical golf bag support member extends upward from said base platform in said second position;
an upper horizontal support member, said upper horizontal support member being secured to said vertical golf bag support member proximate said top end thereof;
a pair of drive wheels, said pair of drive wheels being located on opposing sides of said base platform, said pair of drive wheel being operably coupled to a motor to provide rotation thereof;
a front auxiliary wheel, said front auxiliary wheel being hingedly secured to said base platform proximate said front edge thereof, said front auxiliary wheel extending outward from said base platform; and
a rear auxiliary wheel, said rear auxiliary wheel being hingedly secured to said base platform proximate said rear edge thereof.

10. The golf bag transport device that is configured to carry a golf bag with clubs for a user during a round of play of golf as recited in claim 9, and further including a first transceiver and a second transceiver, said first transceiver mounted to the golf bag transport device, said second transceiver being disposed on the user of the golf bag transport device, said first transceiver and said second transceiver communicably coupled so as to facilitate propulsion of the golf bag transport device in a direction towards the user.

11. The golf bag transport device that is configured to carry a golf bag with clubs for a user during a round of play of golf as recited in claim 10, wherein said front auxiliary wheel and said rear auxiliary wheel are configured to assist in maintaining the golf bag transport device in the upright position while traversing an inclined surface in either an uphill or downhill direction.

12. The golf bag transport device that is configured to carry a golf bag with clubs for a user during a round of play of golf as recited in claim 11, and further including a lower horizontal support member, said lower horizontal support member being secured to said vertical golf bag support member proximate said bottom end thereof.

13. The golf bag transport device that is configured to carry a golf bag with clubs for a user during a round of play of golf as recited in claim 12, and further including a gyroscopic balancing unit, said gyroscopic balancing unit being disposed in said housing under said base platform, said gyroscopic balancing unit configured to maintain the golf bag transport device in an upright position while the golf bag transport device is traversing along a surface.

14. The golf bag transport device that is configured to carry a golf bag with clubs for a user during a round of play of golf as recited in claim 13, wherein said upper horizontal support member and said lower horizontal support member are u-shaped.
